(19) United States
(12) Patent Application Publication
(10) Pub. No.: US 2017/0136482 A1
(43) Pub. Date: May 18, 2017

(54) POWDER SPRAY COATING BOOTH

(71) Applicant: GEMA SWITZERLAND GMBH, St. Gallen (CH)

(72) Inventors: Felix Mauchle, Abtwil (CH); Peter Steiger, Haggenschwil (CH)

(21) Appl. No.: 15/313,879

(22) PCT Filed: Apr. 22, 2015
(86) PCT No.: PCT/EP2015/058647

§ 371 Date: Nov. 23, 2016

(30) Foreign Application Priority Data
May 26, 2014 (DE) 10 2014 107 396.7

(51) Int. Cl. B05B 15/12

(52) U.S. Cl. CPC B05B 15/1229; B05B 15/1222; B05B 15/1285

(57) ABSTRACT

The invention relates to a powder spray coating booth (1) in which objects can be coated with powder with the aid of at least one spray device (6), wherein the powder spray coating booth (1) has an exhaust channel arrangement for exhausting air and excess powder from the booth interior of the powder spray coating booth (1), and wherein the exhaust channel arrangement has an exhaust channel (9) which is arranged in the booth substructure and which is fluidically connected to the booth interior via at least one exhaust opening (8). In order to achieve that a change of powder can also be quickly carried out, the invention provides that the exhaust channel (9) is additionally fluidically connected or can be additionally fluidically connected to at least two channel sections (31, 32) which are led out of the booth substructure, via a manifold (30) arranged in the booth substructure.

The present invention relates to a powder spray coating booth in accordance with the preamble of independent claim 1.

Accordingly, the invention relates in particular to a powder spray coating booth in which objects can be coated with powder by means of a spraying device. In order to be able to exhaust air and excess powder out of the interior of the booth, the powder spray coating booth is provided with a suction channel arrangement comprising a suction channel disposed in the booth substructure, the first end of which is fluidly connected to the booth interior by means of at least one exhaust vent.

A powder spray coating booth of this type is known for example from printed publication EP 0 839 583 A2. This booth is a vertically cylindrical booth having a funnel-shaped booth floor which has a suction port in the center of the booth for an external source of suction.

A similar cylindrical powder spray coating booth is known from printed publication DE 195 00 872. Additionally to the booth floor being configured as a suction funnel, this powder spray coating booth has a gutter-like bottom edge along the booth wall via which air and powder particles can also be suctioned out of the booth separately from the suction flow of the suction funnel.

The DE 198 37 877 A1 printed publication discloses a vertically cylindrical powder coating booth having a flat base plate. A diametric slot extends through the base plate into which powder particles lying on the booth floor can be pushed by a rotating cleaning unit.

Spray coating powder is usually conveyed pneumatically to spraying devices, so-called spray guns, which then spray the objects to be coated by pneumatic and electrostatic means. A slight negative pressure is usually maintained in the spray coating booths during the spray coating process so that no powder particles can escape from the coating booth to the outside. The negative pressure normally maintained in spray coating booths during the spray coating process further serves in suctioning off excess powder; i.e. powder particles ricocheting off or not landing on the object.

In generic powder spray coating booths, excess powder is suctioned off so as to prevent high concentrations of powder in the booth interior which can potentially lead to powder dust explosions. The extraction of excess powder further serves in recovering and reusing of the powder.

A known method of recovering excess powder; i.e. sprayed powder which does not land on the object to be coated or drops off the object, is fluidly connecting a powder separator, for example in form of a filter system, to the booth interior of the powder spray coating booth via an exhaust vent. A suction fan, which is connected for example to an air outlet of the filter system, draws at least a majority of the excess powder and air out of the booth interior of the powder spray coating booth through the filter system. The extracted powder is separated from the suction air in the filter system and falls into a powder container, from which it can be re-supplied together with fresh coating powder to a spraying device for spray coating objects in the powder spray coating booth. The air in the filter system purged of the extracted excess powder is routed by the suction fan into the spatial atmosphere of the powder spray coating booth's equipment room.

On the other hand, using a cyclone system as a powder separator to separate powder from the exhaust air instead of a filter system is likewise known. When employing a cyclone system, which is constructed of for example one or more cyclones, a suction fan extracts excess powder and air from the booth interior through the cyclone system, whereby the powder/air flow is separated into air and powder in the cyclone system by the cyclone centrifugal forces. The separated powder falls into a catch container below the cyclone system while the air purged of powder is usually blown into the external atmosphere through an afterfilter. As a general rule, cyclone systems need such an afterfilter because they cannot separate fine powder particles out of the air flow to the extent that a filter system can. The powder separated by the cyclone system is usually treated as waste although it could also be reprocessed and reused for spray coating.

Powder spray coating booths used for short coating times with specific types of powder or when there is frequent change in powder type are often of cylindrical configuration since cylindrical powder coating booths can be cleaned faster than powder spray coating booths having a rectangular booth interior and thus allow a faster color change.

The term “color change” as used herein refers to changing from one type of powder to another type of powder, particularly another color of powder. Given a large color palette and short coating periods for individual types of powder, there are not insignificant downtimes associated with cleaning the powder spray coating booth and the used powder separator when changing from one powder type to another powder type, as a result of which operating the powder spray coating booth then at the least becomes expensive and inefficient when no main color is being applied during more than 50% of the powder spray coating booth's uptime.

The invention addresses solving the task of further developing a powder spray coating booth of the type cited at the outset to the effect of also being able to realize a fast change of powder when the booth interior is of rectangular form, particularly in the case of powder spray coating booths in which a main color is being applied during more than 50% of the time the powder spray coating booth is in operation.

The invention solves this task by means of the subject matter of independent claim 1, whereby advantageous further developments of the inventive powder spray coating booth are set forth in the independent claims.

Accordingly, for a powder spray coating booth of the type cited at the outset, it is particularly provided for the suction channel disposed in the booth substructure to be fluidly connected or connectable to at least two channel sections leading out of the booth substructure via a manifold likewise preferably arranged in the booth substructure.

The solution according to the invention enables the suction channel of the powder spray coating booth to be fluidly connected to alternatively different powder separators such as, for example, cyclone systems and/or filter systems. By so doing, a first powder separator can be used in the coating process with a first powder type/color and a further (second) powder separator can be used in the coating process with another powder type/color without the need to change the powder separator or perform deep cleaning of the powder separator, which would be disadvantageous when changing powder in terms of a fast powder change with only short downtimes.

By not only the suction channel but also the manifold of the suction channel arrangement, by means of which the suction channel is divided into at least two channel sections, being arranged in the booth substructure of the powder spray coating booth in the inventive solution, a compact design to the powder spray coating booth is furthermore ensured, the space it occupies being unchanged in comparison with conventional powder spray coating booths known from the prior art.

In an easily realized and yet effective configuration of the inventive powder spray coating booth, the manifold disposed in the booth substructure is configured as a T-piece or a Y-piece having one inlet and two outlets. The inlet of the manifold is fluidly connected/connectable to the suction channel while the two outlets of the manifold are each fluidly connected or connectable to a respective one of the channel sections leading out of the booth substructure.

This enables two powder separators acting independently of one another to be connected to the suction channel arrangement, whereby—depending on which powder type is being sprayed in the powder spray coating process—one of the two powder separators is fluidly connected to the suction channel of the suction channel arrangement.

Alternatively hereto, it is at the same time conceivable for the manifold disposed in the booth substructure of the powder spray coating booth to be of star-shaped or cross-shaped configuration so that the manifold can have a plurality (more than two) outlets in addition to one inlet. This thereby enables the inlet of the manifold to be fluidly connected or connectable to the suction channel disposed in the booth substructure while the plurality of manifold outlets are each fluidly connected or connectable to a respective one channel section leading out of the booth substructure.

This embodiment thus enables more than two powder separators to be attached to the powder spray coating booth so that the powder spray coating booth is equipped for use with more than two types of powder without there being prolonged downtimes for cleaning the powder spray coating booth and/or powder separator or for changing powder separator(s) when a powder is changed.

In one preferential further development of the inventive powder spray coating booth, a flow-switching device is provided in order to alternatingly form or cut off a fluid connection between the suction channel disposed in the booth substructure and one of the at least two channel sections leading out of the booth substructure. In conjunction hereto, it is for example conceivable for the flow-switching device to comprise at least one valve flap or at least one valve gate.

Particularly preferential in conjunction hereto is for the flow-switching device to have exactly one valve flap or one valve gate per channel section leading out of the booth substructure so as to be able to cut off a fluid connection between the relevant channel section and the powder separator associated with said channel section when needed.

The following will reference the drawings in describing an example embodiment of the powder spray coating booth according to the invention in greater detail.

Shown are:

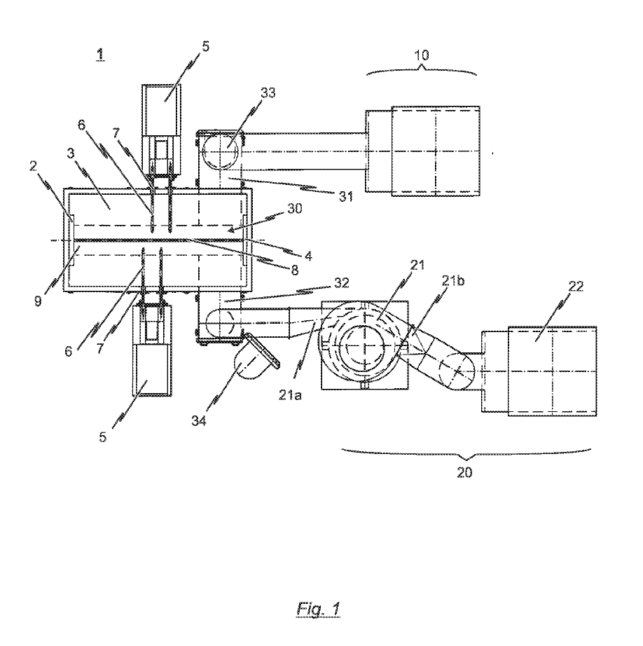

FIG. 1 a schematic top view of an example embodiment of the powder spray coating booth according to the invention in a first operating state; and

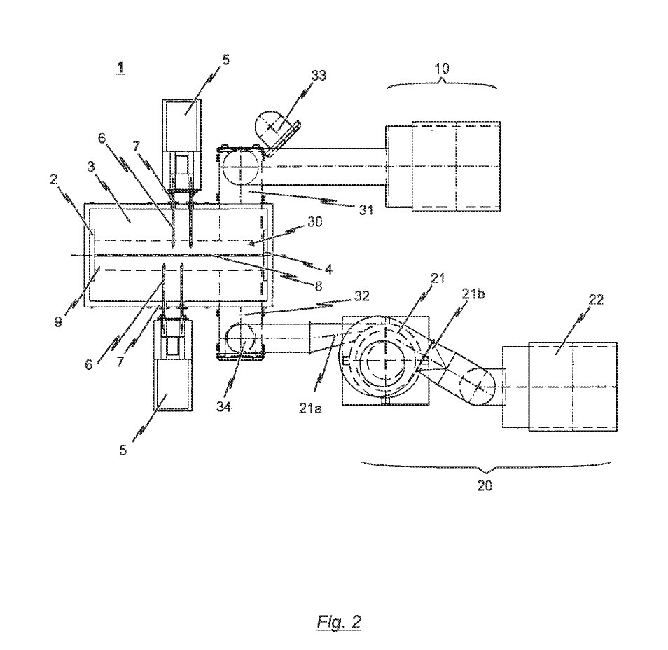

FIG. 2 a schematic top view of the example embodiment of the inventive powder spray coating booth in a second operating state.

The powder spray coating booth 1 according to the invention depicted in the drawings contains two object wall passages 2 and 4 arranged diametrically opposite from one another for the conveying of objects to be coated through the powder spray coating booth 1. The powder spray coating booth 1 is further provided with a booth floor 3.

The width of the object wall passages 2 and 4 limits the maximum width of the object transport path; i.e. the maximum width of the coatable objects inside the powder spray coating booth 1.

Positioning devices 5 are laterally arranged external of the powder spray coating booth 1, for example in the form of lifting stands, which each support at least one spraying device 6 (in the drawings exactly two) and which can move up and down vertically to coat an object to be coated with powder in the booth interior of the powder spray coating booth 1. To this end, each spraying device 6 extends from the positioning device 5 into the interior of the booth through a respective vertical wall slot 7 of the powder spray coating booth 1.

The object to be coated is transported through the powder spray coating booth 1 transverse to the longitudinal direction of the spraying devices 6 by a transport mechanism, for example a continuous conveyor belt.

The spraying devices 6 preferably comprise one or more high-voltage electrodes for electrostatically charging the coating powder and a high-voltage generator for producing the high voltage for the high-voltage electrodes.

The powder spray coating booth 1 depicted schematically in the drawings exhibits a rectangular booth wall when viewed in horizontal section and a booth floor 3 which separates the booth interior of the powder spray coating booth 1 from the booth substructure.

In the context of the present description, all the elements which are disposed in a powder spray coating booth 1 below the path of movement of the coating objects to be coated and below the spray jets of the spraying devices, the latter also known as spray guns, are collectively referred to as the “booth floor.” The “booth substructure” identifies the space underneath the booth floor 3.

At least one longitudinally extending longitudinal floor slot 8 is formed in the booth floor 3 of the powder spray coating booth 1. This at least one longitudinal floor slot 8 fluidly connects the booth interior of the powder spray coating booth 1 to a suction channel 9. Dotted lines are used to depict the suction channel 9 in the drawings since it is arranged underneath the booth floor 3; i.e. in the booth substructure of the powder spray coating booth 1. As can further be seen from the drawings, the suction channel 9 arranged in the booth substructure preferably extends over the entire length of the booth.

The suction channel 9 disposed in the booth substructure is part of a suction channel arrangement via which excess powder can be suctioned out of the booth interior. To this end, the excess powder which drops during the spraying of coating powder is drawn off into the suction channel 9 through the at least one longitudinal floor slot 8. The suction channel 9 is connected by means of a fluid line system to at least one powder suction mechanism, preferably to at least one powder separator for recovering powder.

In the example embodiment of the inventive powder spray coating booth 1 depicted in the drawings, two independently connectable powder separators 10, 20 are employed as the powder recovery device for recovering the excess powder suctioned out of the booth interior:

Firstly, a first powder separator 10 designed as a filter unit is provided here which serves in separating powder out of the powder/air suction flow drawn out of the booth interior and thereafter in blowing air purged of powder out into the environment.

The powder separated by the filter unit of the first powder separator 10 falls into a powder container and can then be re-fed to the spraying devices 6 via a powder line, preferably together with fresh powder. Means for treating the powder, e.g. a sieve, can be arranged in the flow path between the filter unit and the powder container.

Secondly, a cyclone unit 21 with a downstream filter unit (afterfilter 22) is provided in the embodiment depicted schematically in the drawings as an example further powder separator 20. The cyclone unit 21 has a cyclone flow inlet 21a and a cyclone air outlet 21b as well as a cyclone mechanism in the flow path between the two for separating powder out of the powder/air suction flow by the cyclone centrifugal forces. The cyclone flow inlet 21a is formed at the upstream start of a cyclone line (duct or tube). The cyclone air outlet 21b is connected to the afterfilter 22 which filters out the remaining powder which the cyclone mechanism is unable to separate out.

As is also the case with the filter unit of the first powder separator 10, the powder separated by the afterfilter 22 falls into a powder container and can then be re-fed to the spraying devices 6, preferably together with fresh powder, via a powder line. The powder separated out of the powder/air flow by the cyclone unit 21 of the second powder separator 20 falls through a cyclone powder outlet at the bottom of the cyclone into a collection container. The powder in the collection container can be deemed waste or can be treated and fed back to the spraying devices 6 in the same way as the powder of the filter unit's powder container.

Although a filter unit is provided as the first powder separator 10 and a cyclone unit 21 with a downstream filter unit provided as the second powder separator 20 in the example embodiment depicted in the drawings, this realization of the powder separators 10, 20 is not to be regarded as being restrictive. In fact, it is for example also conceivable for both powder separators 10, 20 to each be configured as a filter unit or as a cyclone unit with a downstream filter unit.

In order to alternatingly conduct the flow of the powder/air mixture through the first powder separator 10 or through the second powder separator 20, the powder spray coating booth 1 comprises a manifold 30 disposed in the booth substructure which has at least two channel sections 31, 32 leading out from the booth substructure.

In the example embodiment depicted in the drawings, the manifold 30 arranged in the booth substructure is of T-shaped configuration and comprises an inlet fluidly connected to the suction channel 8. Each of the two outlets of the manifold 30 is fluidly connected to one respective channel section 31, 32 leading out (laterally) from the booth substructure.

A flow-switching device 33, 34 is allocated to each channel section 31, 32 in order to cut off a fluid connection between the respective channel section 31, 32 and a powder separator 10, 20 associated with the channel section 31, 32 when needed.

In the operating state of the example embodiment of the inventive powder spray coating booth 1 depicted schematically in FIG. 1, the flow-switching device 32 associated with the lower channel section 32 is open, for example, so that the lower channel section 32 is fluidly connected to the associated second powder separator 20 (here: cyclone unit and afterfilter).

At the same time, the flow-switching device 33 allocated to the upper channel section 31 is closed so that a fluid connection between the upper channel section 31 and associated first powder separator 10 (here: filter means) is cut off.

FIG. 2 shows an operating state of the powder spray coating booth 1 in which the flow-switching device 33 allocated to the upper channel section 31 is open and the flow-switching device 34 allocated to the lower channel section 32 is closed. In consequence thereof, the upper channel section 31 is fluidly connected to the correspondingly associated first powder separator 10 while a fluid connection between the lower channel section 32 and associated second powder separator 20 is cut off.

In the embodiment depicted in the drawings, the flow-switching devices 33, 34 are respectively realized as manually actuatable shut-off mechanisms able to be extended and/or retracted into and out of the flow path in order to clear/block the fluid connection between the respective channel section 31, 32 and associated powder separator 10, 20. It is however of course also conceivable for these shut-off mechanisms to be implemented so as to be electrically, pneumatically or hydraulically actuatable. Also conceivable is selecting other embodiments for the flow-switching devices 33, 34 such as, for example, valve flaps, valve gates, etc.

The powder spray coating booth 1 according to the invention enables multi-color operation without laborious cleaning when changing colors by virtue of being able to connect different powder separators 10, 20 as needed. If, for example, a specific (main) color has been allocated to the first powder separator 10, the fluid connection between the first powder separator 10 and the booth interior can be cut off upon changing color from the main color to another color while a fluid connection between the booth interior and the second powder separator 20 is opened.

The invention is not limited to embodiments which make use of only two different powder separators 10, 20. It is in fact also conceivable for even more powder separators to be alternatingly connected. In this case, the manifold 30 disposed in the booth substructure should exhibit a star-shaped configuration.

The invention is in particular also characterized by the largest part of the suction channel arrangement being disposed in the booth substructure of the powder spray coating booth 1 such that there is essentially no change to the amount of space occupied by the powder spray coating booth 1.

The invention is not limited to powder spray coating booths having a substantially rectangular booth interior. On the contrary, the invention is obviously also advantageous in combination with a vertically cylindrical booth.

1. A powder spray coating booth (1) in which objects can be coated with powder by means of a spraying device (6), wherein the powder spray coating booth (1) comprises a suction channel arrangement for suctioning air and excess powder out of the booth interior of the powder spray coating booth (1), and wherein the suction channel arrangement has a suction channel (9) disposed in the booth substructure which is fluidly connected to the booth interior by means of at least one exhaust vent (8), the suction channel (9) is further fluidly connected or connectable to at least two channel sections (31, 32) leading out of the booth substructure by means of a manifold (30) arranged in the booth substructure, characterized in that
the manifold (30) is configured as a T-piece or a Y-piece having one inlet and two outlets, wherein the inlet of the manifold (30) is fluidly connected or connectable to the suction channel (9) and the two outlets of the manifold (30) are each fluidly connected or connectable to a respective one of the channel sections (31, 32) leading out of the booth substructure; or
the manifold (30) is of star-shaped or cross-shaped configuration and comprises one input and a plurality of outlets, wherein the inlet of the manifold (30) is fluidly connected or connectable to the suction channel (9) and the plurality of outlets of the manifold (30) are each fluidly connected or connectable to a respective one channel section (31, 32) leading out of the booth substructure.

2. (canceled)

3. (canceled)

4. The powder spray coating booth (1) according to claim 1,
wherein the suction channel (9) provided in the booth substructure is preferably centrally arranged, and wherein the suction channel (9) is fluidly connected to the booth interior by means of a least one suction slot.

5. The powder spray coating booth (1) according to claim 1,
wherein a flow-switching device is provided to alternatingly form and cut off a fluid connection between the suction channel (9) disposed in the booth substructure and one of the at least two channel sections (31, 32) leading out of the booth substructure.

6. The powder spray coating booth (1) according to claim 1,
wherein each of the channel sections (31, 32) leading out of the booth substructure is allocated a powder separator (10, 20), to which the respective channel section (31, 32) can be alternatingly fluidly connected and connectable by means of a flow-switching device (33, 34) allocated to the respective channel section (31, 32).

7. The powder spray coating booth (1) according to claim 5 or 6,
wherein the flow-switching device (33, 34) comprises at least one valve flap or at least one valve gate and preferably exactly one valve flap or exactly one valve gate per channel section (31, 32) leading out of the booth substructure in order to cut off a fluid connection between the relevant channel section and the powder separator (10, 20) associated with said channel section (31, 32) when needed.

8. The powder spray coating booth (1) according to claim 6 or 7,
wherein the powder separator comprises a cyclone system (21) and/or a system (22).

9. The powder spray coating booth (1) according to claim 1, 4, 5, 6, 7, or 8,
wherein a first channel section (31) leading out of the booth substructure is fluidly connected or connectable to a first powder separator (10), and wherein a second channel section (32) leading out of the booth substructure is fluidly connected or connectable to a second powder separator (20), and wherein a first type of powder or color of powder being or to be sprayed in the powder spray coating booth (1) is allocated to the first powder separator (10) and a second type of powder or color of powder being or to be sprayed in the powder spray coating booth (1) is allocated to the second powder separator (20).
